(19) United States
(12) Patent Application Publication
(10) Pub. No.: US 2026/0081074 A1
(43) Pub. Date: Mar. 19, 2026

(54) MULTILAYER CERAMIC CAPACITOR AND MOUNT STRUCTURE FOR MULTILAYER CERAMIC CAPACITOR

(71) Applicant: Murata Manufacturing Co., Ltd., Nagaokakyo-shi (JP)

(72) Inventor: Kentaro FUJIWARA, Nagaokakyo-shi (JP)

(21) Appl. No.: 19/196,120

(22) Filed: May 1, 2025

(30) Foreign Application Priority Data
Sep. 13, 2024 (JP) 2024-158709

(51) Int. Cl. H01G 4/232; H01G 2/06; H01G 4/008; H01G 4/012; H01G 4/12; H01G 4/33

(52) U.S. Cl. CPC H01G 4/232; H01G 2/065; H01G 4/008; H01G 4/012; H01G 4/1227; H01G 4/33

(57) ABSTRACT

A multilayer ceramic capacitor includes a multilayer body including layered dielectric layers and internal electrode layers, first, second, third, and fourth external electrodes respectively on third, fourth, fifth, and sixth surfaces. The internal electrode layers include first and second internal electrode layers respectively exposed at the third and fourth surfaces and the fifth and sixth surfaces. The multilayer body includes a capacitance generating portion in which the first and second internal electrode layers are opposed, first and second outer layer portions respectively between first and second surfaces and the capacitance generating portion. A third internal electrode layer opposed to the first internal electrode layer in at least one of the first and second outer layer portions, and a length in a first direction of the third internal electrode layer is shorter than a length in the first direction of the second internal electrode layer.

### CROSS REFERENCE TO RELATED APPLICATIONS

This nonprovisional application claims the benefit of priority to Japanese Patent Application No. 2024-158709 filed with the Japan Patent Office on Sep. 13, 2024. The entire contents of this application are hereby incorporated herein by reference.

### BACKGROUND OF THE INVENTION

### 1. Field of the Invention

The present invention relates to multilayer ceramic capacitors and mount structures for multilayer ceramic capacitors.

### 2. Description of the Related Art

A decoupling capacitor used for stabilization of a supply voltage supplied to an integrated circuit component (IC) that operates at a high speed or a feedthrough multilayer ceramic capacitor used as measures against noise of a power line supplied to an integrated circuit component (IC) has been known. For example, the feedthrough multilayer ceramic capacitor generally includes a ceramic element (multilayer body) including an outer surface including first and second main surfaces opposed to each other, first and second side surfaces opposed to each other, and first and second end surfaces opposed to each other. A plurality of first internal electrodes and a plurality of second internal electrodes are alternately arranged inside the ceramic element in a layering direction. The first internal electrode includes opposing ends extending to the first end surface and the second end surface and connected to a first external electrode and a second external electrode, respectively. The second internal electrode includes opposing ends extending to the first side surface and the second side surface and connected to a third external electrode and a fourth external electrode, respectively.

Japanese Patent Laid-Open No. 2003-022932 discloses, as such a feedthrough multilayer ceramic capacitor, a feedthrough three-terminal electronic component which includes a multilayer body having such a structure that at least one set of a signal internal electrode and a ground internal electrode as being opposed to each other with a dielectric layer being interposed is layered, a pair of signal external electrodes to which drawn portions of the signal internal electrode are connected, and a ground external electrode to which the ground internal electrode is connected.

In the structure as in Japanese Patent Laid-Open No. 2003-022932, however, with a tendency toward a smaller thickness of a layer and a higher capacitance, in order to ensure moisture resistance reliability, an outer layer portion should have a thickness equal to or larger than a certain thickness. With an increase in thickness of an outer layer, disadvantageously, a current path for a radio-frequency current that flows to GND becomes longer and an ESL increases.

### SUMMARY OF THE INVENTION

Example embodiments of the present invention provide multilayer ceramic capacitors and mount structures for multilayer ceramic capacitors that are each able to sufficiently achieve a low ESL effect while meeting demands for a smaller thickness of a layer and a higher capacitance.

A multilayer ceramic capacitor according to an example embodiment of the present invention includes a multilayer body including a plurality of layered dielectric layers and a plurality of internal electrode layers layered on the dielectric layers, a first surface and a second surface opposed to each other in a layering direction, a third surface and a fourth surface opposed to each other in a first direction orthogonal or substantially orthogonal to the layering direction, and a fifth surface and a sixth surface opposed to each other in a second direction orthogonal or substantially orthogonal to the layering direction and the first direction, a first external electrode on the third surface, a second external electrode on the fourth surface, a third external electrode on the fifth surface, and a fourth external electrode on the sixth surface. The plurality of internal electrode layers include a first internal electrode layers on the plurality of dielectric layers and exposed at the third surface and the fourth surface, second internal electrode layers on the plurality of dielectric layers and exposed at the fifth surface and the sixth surface, and third internal electrode layers on the plurality of dielectric layers and exposed at the fifth surface and the sixth surface. The multilayer body includes a capacitance generating portion in which the first internal electrode layers and the second internal electrode layers are opposed to each other to generate a capacitance, a first outer layer portion between the first surface and the capacitance generating portion, and a second outer layer portion between the second surface and the capacitance generating portion. The third internal electrode layer includes an opposing portion opposed to the first internal electrode layer in at least one of the first outer layer portion and the second outer layer portion. A length in the first direction of the third internal electrode layer is shorter than a length in the first direction of the second internal electrode layer.

According to a multilayer ceramic capacitor according to an example embodiment of the present invention, the multilayer body includes the third internal electrode layer on the plurality of dielectric layers and exposed at the fifth surface and the sixth surface, the multilayer body includes the capacitance generating portion in which the first internal electrode layers and the second internal electrode layers are opposed to each other to generate the capacitance, the first outer layer portion between the first surface and the capacitance generating portion, and the second outer layer portion between the second surface and the capacitance generating portion, the third internal electrode layer includes the opposing portion opposed to the first internal electrode layers arranged in at least one of the first outer layer portion and the second outer layer portion, and the length in the first direction of the third internal electrode layer is shorter than the length in the first direction of the second internal electrode layer. Therefore, while good moisture resistance reliability is ensured, the current path for the radio-frequency current that flows to the GND becomes shorter and the low ESL can be achieved.

A mount structure for a multilayer ceramic capacitor according to an example embodiment of the present invention includes a mount substrate and a multilayer ceramic capacitor according to an example embodiment of the present invention mounted on the mount substrate. The mount substrate includes a core material of a substrate, a first connection conductor connected to the first external electrode on the core material, a second connection conductor connected to the second external electrode on the core material, a third connection conductor connected to the third external electrode on the core material, and a fourth connection conductor connected to the fourth external electrode on the core material. The multilayer ceramic capacitor is mounted such that the first surface or the second surface faces the mount substrate.

According to a mount structure for a multilayer ceramic capacitor according to an example embodiment of the present invention, the third internal electrode layer includes the opposing portion opposed to the first internal electrode layer arranged in at least one of the first outer layer portion and the second outer layer portion, the length in the first direction of the third internal electrode layer is shorter than the length in the first direction of the second internal electrode layer, and the multilayer ceramic capacitor is mounted such that the first surface provided with the first outer layer portion or the second surface provided with the second outer layer portion faces the mount substrate. Therefore, a current path from the third internal electrode layer of the multilayer ceramic capacitor to the mount substrate can be shorter. Consequently, according to the mount structure for the multilayer ceramic capacitor according to the present example embodiment, the current path for the radio-frequency current that flows to the GND becomes shorter and the low ESL can be achieved.

According to example embodiments of the present invention, multilayer ceramic capacitors and mount structures for multilayer ceramic capacitors are each able to sufficiently achieve a low ESL effect while meeting demands for a smaller thickness of a layer and a higher capacitance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing an exemplary multilayer ceramic capacitor according to an example embodiment of the present invention.

FIG. 2 is a top view showing an exemplary multilayer ceramic capacitor according to an example embodiment of the present invention.

FIG. 3 is a bottom view showing an exemplary multilayer ceramic capacitor according to an example embodiment of the present invention.

FIG. 4 is a side view showing an exemplary multilayer ceramic capacitor according to an example embodiment of the present invention.

FIG. 5 is a cross-sectional view along the line V-V in FIG. 1.

FIG. 6 is a cross-sectional view along the line VI-VI in FIG. 1.

FIG. 7 is a cross-sectional view along the line VII-VII in FIG. 4.

FIG. 8 is a cross-sectional view along the line VIII-VIII in FIG. 4.

FIG. 9 is a cross-sectional view along the line IX-IX in FIG. 4.

FIG. 10 shows a modification of a third internal electrode included in a multilayer ceramic capacitor according to an example embodiment of the present invention.

FIG. 11 is a cross-sectional view in a first direction showing an exemplary mount structure for a multilayer ceramic capacitor according to an example embodiment of the present invention.

FIG. 12 is a cross-sectional view in a second direction showing an exemplary mount structure for a multilayer ceramic capacitor according to an example embodiment of the present invention.

### DETAILED DESCRIPTION OF THE EXAMPLE EMBODIMENTS

Example embodiments of the present invention will be described in detail below with reference to the drawings.

### 1. Multilayer Ceramic Capacitor

A multilayer ceramic capacitor 10 according to an example embodiment of the present invention will be described. Multilayer ceramic capacitor 10 is, for example, a feedthrough multilayer ceramic capacitor (three-terminal multilayer ceramic capacitor).

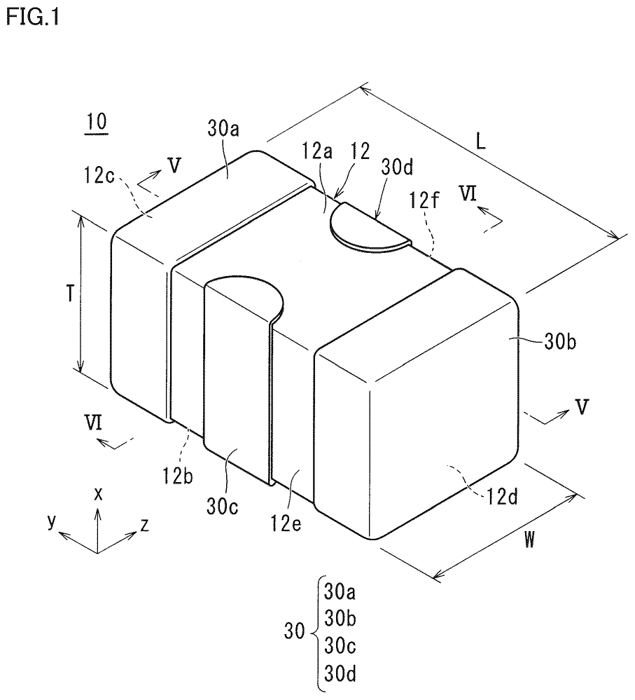

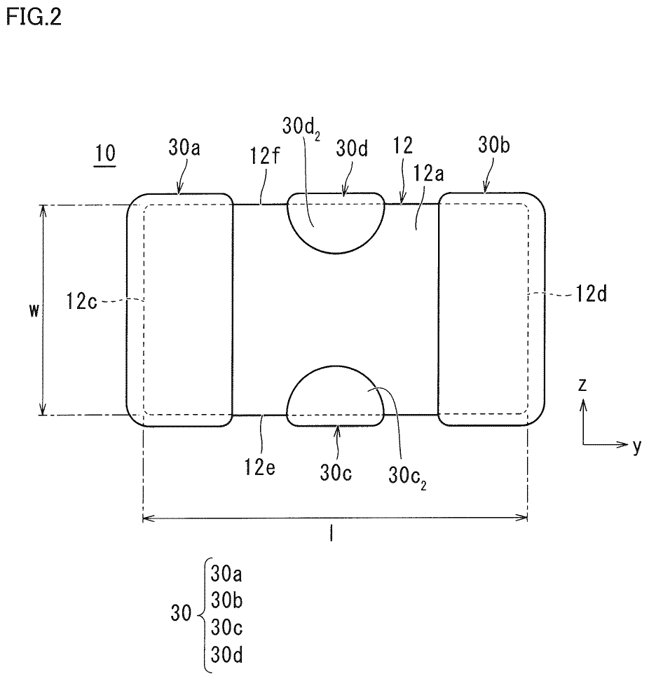

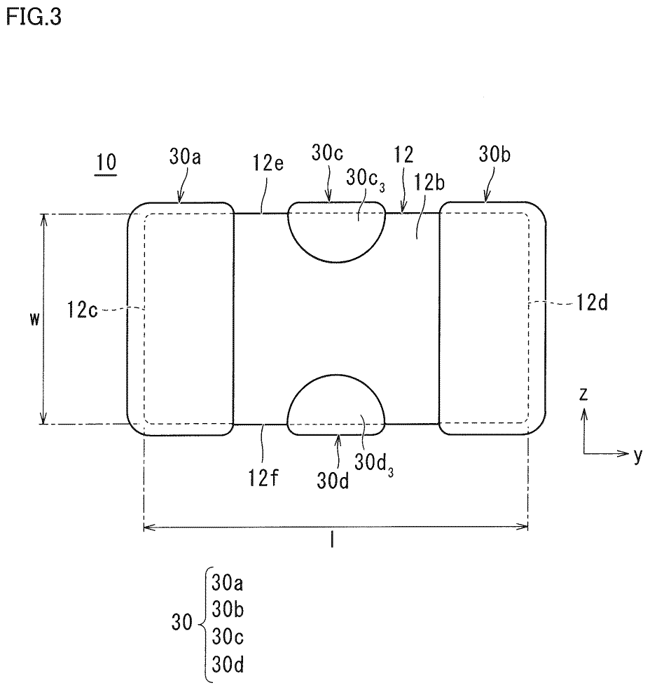

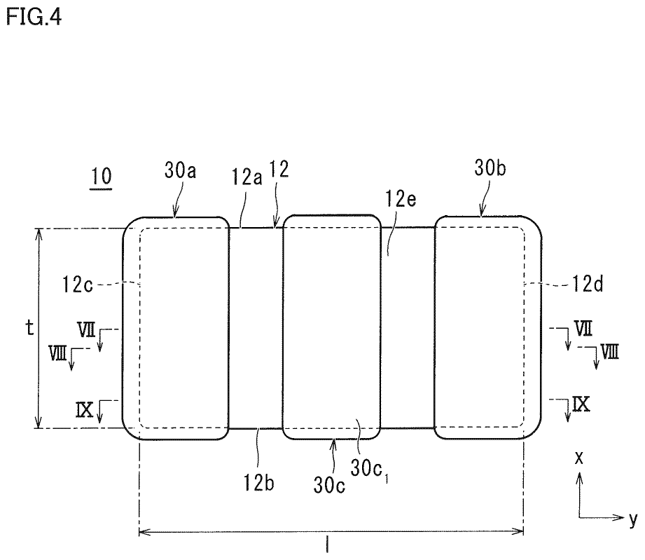

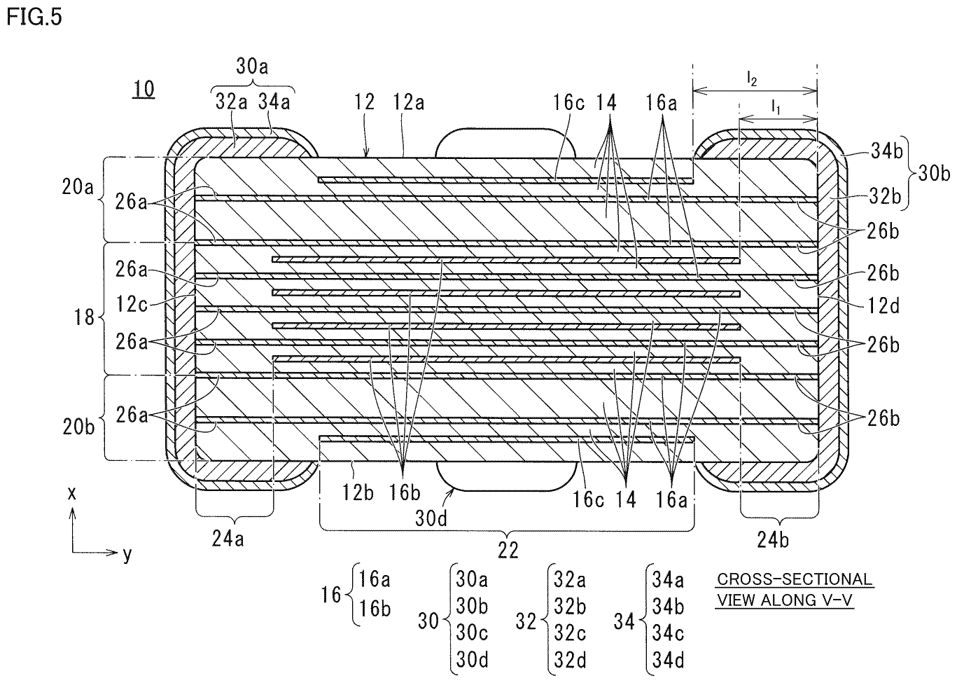

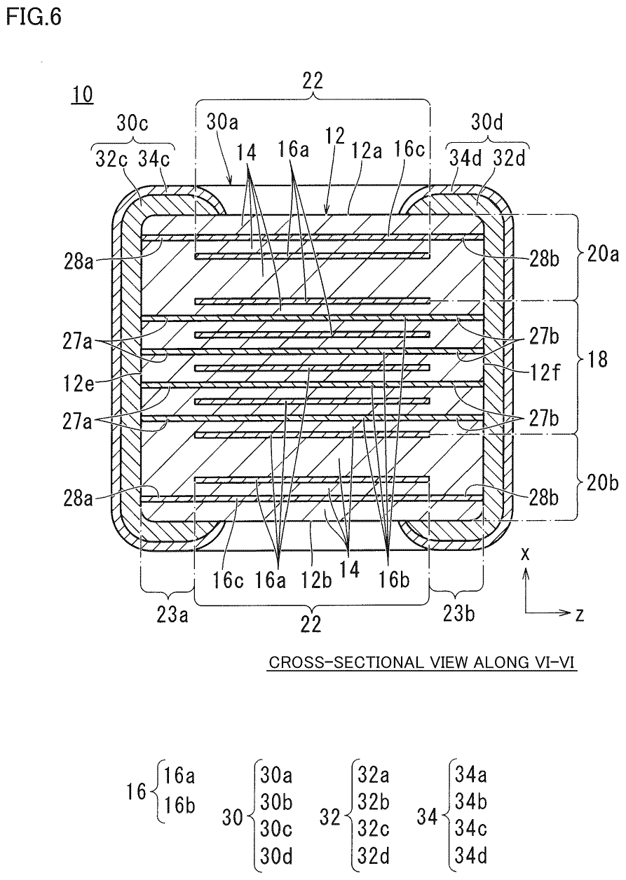

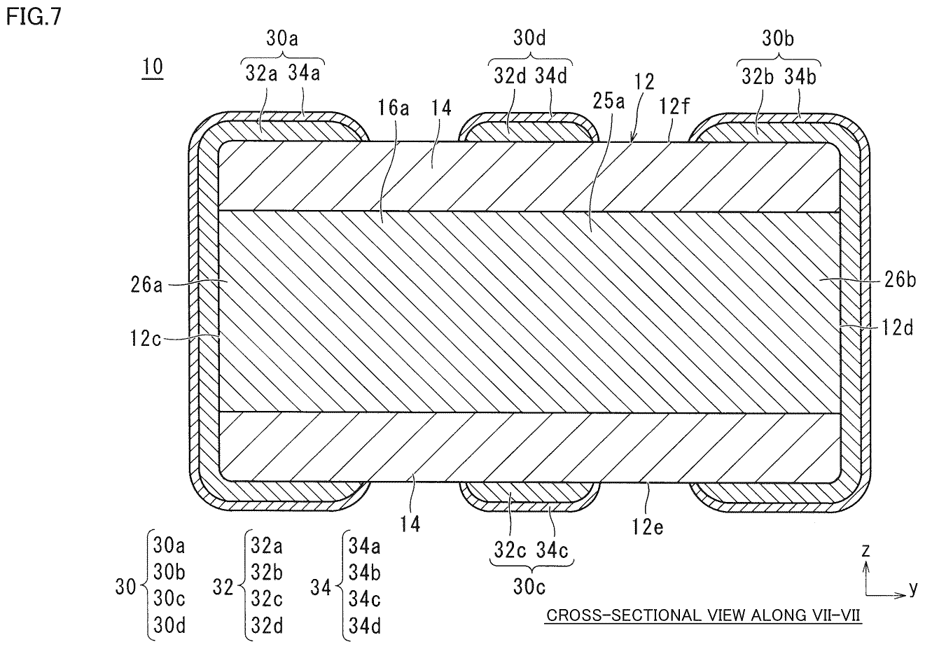

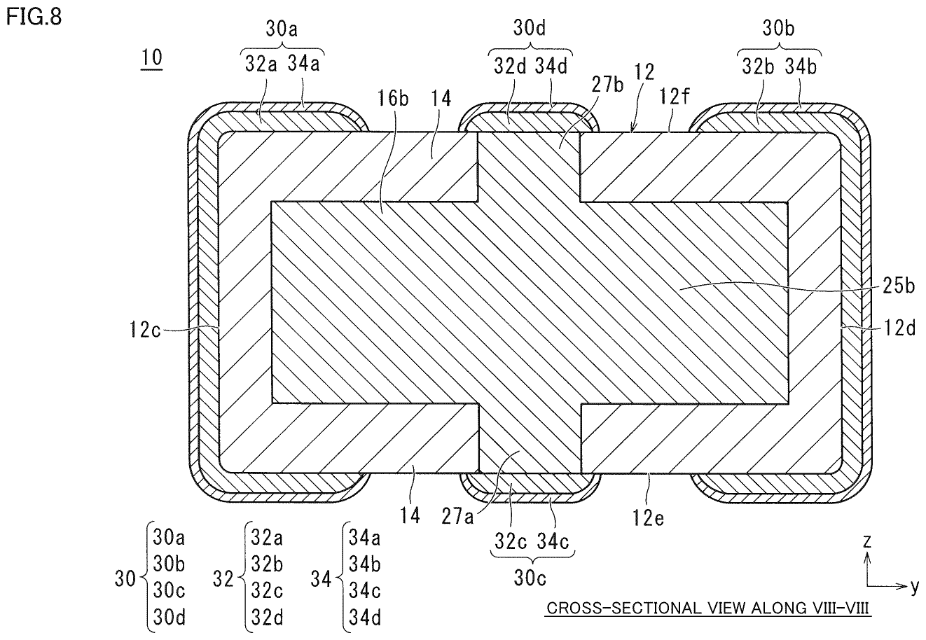

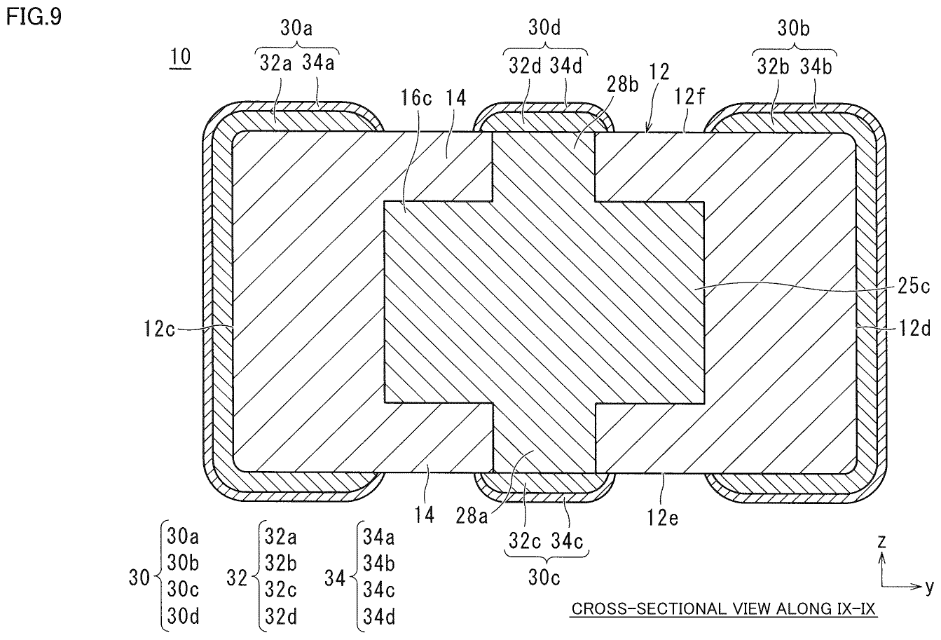

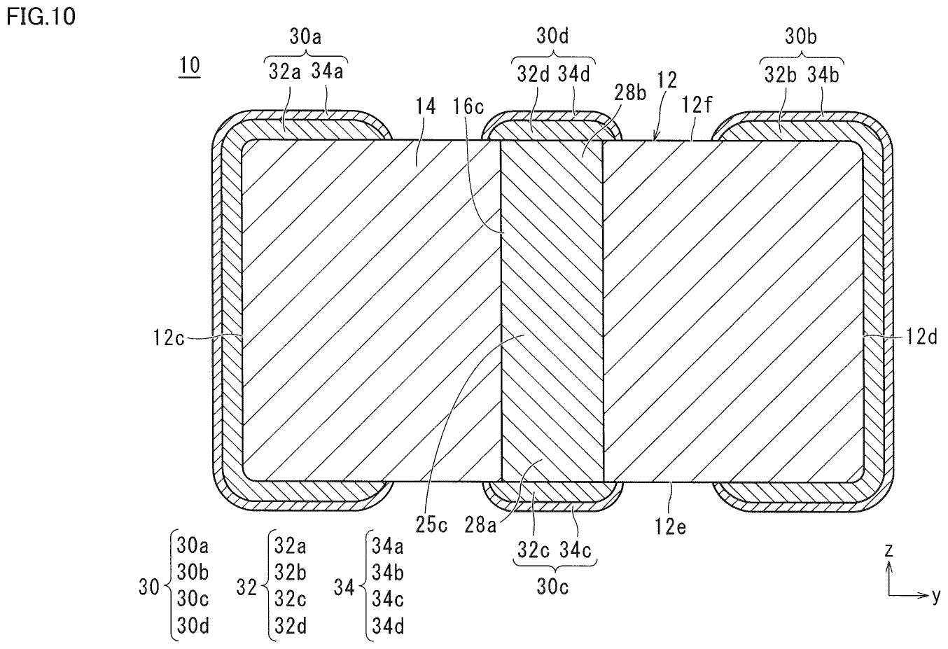

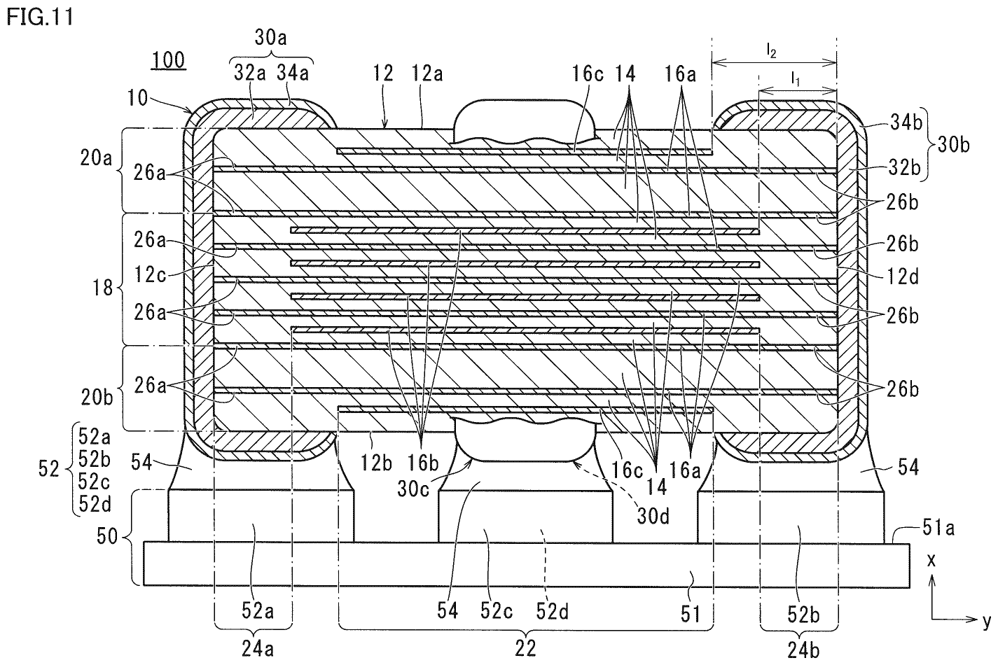

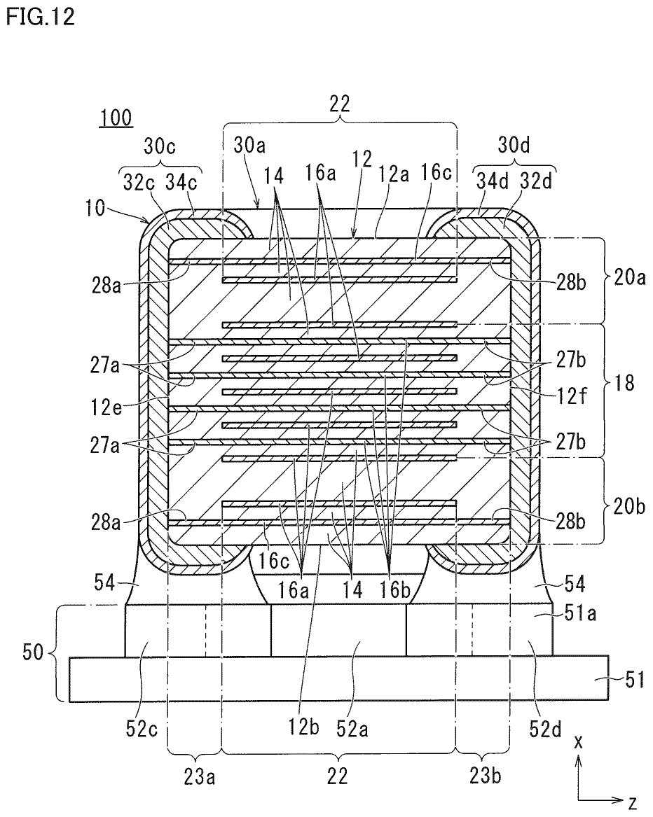

FIG. 1 is an external perspective view showing an exemplary multilayer ceramic capacitor according to an example embodiment of the present invention. FIG. 2 is a top view showing an exemplary multilayer ceramic capacitor according to an example embodiment of the present invention. FIG. 3 is a bottom view showing an exemplary multilayer ceramic capacitor according to an example embodiment of the present invention. FIG. 4 is a side view showing an exemplary multilayer ceramic capacitor according to an example embodiment of the present invention. FIG. 5 is a cross-sectional view along the line V-V in FIG. 1. FIG. 6 is a cross-sectional view along the line VI-VI in FIG. 1. FIG. 7 is a cross-sectional view along the line VII-VII in FIG. 4. FIG. 8 is a cross-sectional view along the line VIII-VIII in FIG. 4. FIG. 9 is a cross-sectional view along the line IX-IX in FIG. 4. FIG. 10 shows a modification of a third internal electrode included in a multilayer ceramic capacitor according to an example embodiment of the present invention. FIG. 11 is a cross-sectional view in a first direction showing an exemplary mount structure for a multilayer ceramic capacitor according to an example embodiment of the present invention. FIG. 12 is a cross-sectional view in a second direction showing an exemplary mount structure for a multilayer ceramic capacitor according to an example embodiment of the present invention.

As shown in FIGS. 1 to 9, multilayer ceramic capacitor 10 includes, for example, a multilayer body 12 and an external electrode 30.

Multilayer body 12 includes a plurality of layered dielectric layers 14 and a plurality of internal electrode layers 16 layered on dielectric layers 14. Internal electrode layers 16 include a first internal electrode layer 16a, a second internal electrode layer 16b, and a third internal electrode layer 16c. Details of first internal electrode layer 16a, second internal electrode layer 16b, and third internal electrode layer 16c will be described later.

Multilayer body 12 includes a first surface 12a and a second surface 12b opposed to each other in a layering direction x, a third surface 12c and a fourth surface 12d opposed to each other in a first direction y orthogonal or substantially orthogonal to layering direction x, and a fifth surface 12e and a sixth surface 12f opposed to each other in a second direction z orthogonal or substantially orthogonal to layering direction x and first direction y.

Multilayer body 12 has a parallelepiped shape and multilayer body 12 preferably includes a corner portion and a ridgeline portion rounded. The corner portion is a portion where three surfaces of multilayer body 12 meet one another and the ridgeline portion is a portion where two surfaces of multilayer body 12 meet each other. A portion or the entirety of first surface 12a and second surface 12b, third surface 12c and fourth surface 12d, and fifth surface 12e and sixth surface 12f may include asperities or the like.

A dimension in first direction y of multilayer body 12 is defined as a l dimension, a dimension in second direction z of multilayer body 12 is defined as a w dimension, and a dimension in layering direction x of multilayer body 12 is defined as a t dimension.

Multilayer body 12 includes a capacitance generating portion 18 and a first outer layer portion 20a located on a side of first surface 12a and a second outer layer portion 20b located on a side of second surface 12b, first outer layer portion 20a and second outer layer portion 20b being arranged such that capacitance generating portion 18 is provided therebetween in layering direction x.

In capacitance generating portion 18, first internal electrode layer 16a and second internal electrode layer 16b are alternately layered with dielectric layer 14 being interposed therebetween.

First outer layer portion 20a is located on the side of first surface 12a of multilayer body 12 and located between first surface 12a and capacitance generating portion 18 closest to first surface 12a. First outer layer portion 20a is an assembly of a plurality of dielectric layers 14 which includes first internal electrode layer 16a and third internal electrode layer 16c. Second outer layer portion 20b is located on the side of second surface 12b of multilayer body 12 and located between second surface 12b and capacitance generating portion 18 closest to second surface 12b. Second outer layer portion 20b is an assembly including a plurality of dielectric layers 14 which includes first internal electrode layer 16a and third internal electrode layer 16c. Furthermore, a region between first outer layer portion 20a and second outer layer portion 20b is capacitance generating portion 18.

A thickness of each of first outer layer portion 20a and second outer layer portion 20b is, for example, equal to or larger than about 20 μm.

As shown in FIG. 6, multilayer body 12 includes side portions (W gaps) 23a and 23b of multilayer body 12, the side portions being located between capacitance generating portion 18 and fifth surface 12e and between capacitance generating portion 18 and sixth surface 12f and including a first extension portion 27a and a second extension portion 27b of second internal electrode layer 16b, respectively.

As shown in FIG. 5, multilayer body 12 includes end portions (L gaps) 24a and 24b of multilayer body 12, the end portions being located between capacitance generating portion 18 and third surface 12c and between capacitance generating portion 18 and fourth surface 12d and including a first drawn portion 26a and a second drawn portion 26b of first internal electrode layer 16a, respectively.

Dielectric ceramic including, for example, such a component as BaTiO₃, CaTiO₃, SrTiO₃, or CaZrO₃ can be used as a ceramic material for dielectric layer 14. A material obtained by addition of a sub component such as, for example, an Mn compound, an Fe compound, a Cr compound, a Co compound, or an Ni compound to these main components may be used.

A thickness of dielectric layer 14 is, for example, preferably not smaller than about 0.44 μm and not larger than about 0.60 μm. The number of layered dielectric layers 14 is, for example, preferably not smaller than 325 and not larger than 660. This number of dielectric layers 14 is a total of the number of dielectric layers 14 in capacitance generating portion 18 and the number of dielectric layers 14 in first outer layer portion 20a and second outer layer portion 20b.

### Internal Electrode Layer

Internal electrode layer 16 includes first internal electrode layer 16a, second internal electrode layer 16b, and third internal electrode layer 16c.

First internal electrode layer 16a is arranged on a plurality of dielectric layers 14. First internal electrode layer 16a extends to third surface 12c and fourth surface 12d.

More specifically, as shown in FIG. 7, first internal electrode layer 16a extends between third surface 12c and fourth surface 12d of multilayer body 12 and includes a first opposing electrode portion 25a corresponding to a central portion thereof, first drawn portion 26a that extends from first opposing electrode portion 25a and extends to third surface 12c of multilayer body 12, and second drawn portion 26b that extends from first opposing electrode portion 25a and extends to fourth surface 12d of multilayer body 12. First opposing electrode portion 25a is located at a central portion on dielectric layer 14. First drawn portion 26a is exposed at third surface 12c of multilayer body 12 and second drawn portion 26b is exposed at fourth surface 12d of multilayer body 12. Therefore, first internal electrode layer 16a is not exposed at fifth surface 12e and sixth surface 12f of multilayer body 12.

Although a shape of first internal electrode layer 16a is not particularly limited, the first internal electrode layer is, for example, rectangular preferably or substantially rectangular in a plan view. Although shapes of first opposing electrode portion 25a, first drawn portion 26a, and second drawn portion 26b of first internal electrode layer 16a are not particularly limited, they are, for example, preferably rectangular or substantially rectangular in the plan view. A corner portion may be rounded.

Second internal electrode layer 16b is arranged on a plurality of dielectric layers 14. Second internal electrode layer 16b extends to fifth surface 12e and sixth surface 12f. Second internal electrode layer 16b is arranged on dielectric layer 14 different from dielectric layer 14 on which first internal electrode layer 16a is arranged.

More specifically, as shown in FIG. 8, second internal electrode layer 16b extends between fifth surface 12e and sixth surface 12f of multilayer body 12 and includes a second opposing electrode portion 25b corresponding to a central portion thereof, first extension portion 27a that extends from second opposing electrode portion 25b and extends to fifth surface 12e, and second extension portion 27b that extends from second opposing electrode portion 25b and extends to sixth surface 12f. Second opposing electrode portion 25b has, for example, a rectangular or substantially rectangular shape to extend in a direction toward third surface 12c and to extend in a direction toward fourth surface 12d. Second opposing electrode portion 25b is located at a central portion on dielectric layer 14. First extension portion 27a is exposed at fifth surface 12e of multilayer body 12 and second extension portion 27b is exposed at sixth surface 12f of multilayer body 12. Therefore, second internal electrode layer 16b is not exposed at third surface 12c and fourth surface 12d of multilayer body 12.

Although shapes of second opposing electrode portion 25b, first extension portion 27a, and second extension portion 27b of second internal electrode layer 16b are not particularly limited, the second opposing electrode portion, the first extension portion, and the second extension portion are, for example, preferably rectangular or substantially rectangular in the plan view. A corner portion may be rounded.

First opposing electrode portion 25a of first internal electrode layer 16a and second opposing electrode portion 25b of second internal electrode layer 16b are opposed to each other. In the present example embodiment, first opposing electrode portion 25a of first internal electrode layer 16a and second opposing electrode portion 25b of second internal electrode layer 16b are opposed to each other with dielectric layer 14 being interposed therebetween, SO that a capacitance is generated and characteristics of a capacitor are exhibited.

Third internal electrode layer 16c is arranged on a plurality of dielectric layers 14. Third internal electrode layer 16c extends to fifth surface 12e and sixth surface 12f. Third internal electrode layer 16c is arranged on dielectric layer 14 different from dielectric layer 14 on which first internal electrode layer 16a is arranged.

More specifically, as shown in FIG. 9, third internal electrode layer 16c includes a third opposing electrode portion 25c that extends between fifth surface 12e and sixth surface 12f of multilayer body 12 and corresponds to a central portion thereof, a third extension portion 28a that extends from third opposing electrode portion 25c and extends to fifth surface 12e, and a fourth extension portion 28b that extends from third opposing electrode portion 25c and extends to sixth surface 12f. Third opposing electrode portion 25c has, for example, a rectangular or substantially rectangular shape to extend in the direction toward third surface 12c and to extend in the direction toward fourth surface 12d. Third opposing electrode portion 25c is located at the central portion on dielectric layer 14. Third extension portion 28a is exposed at fifth surface 12e of multilayer body 12 and fourth extension portion 28b is exposed at sixth surface 12f of multilayer body 12. Therefore, third internal electrode layer 16c is not exposed at third surface 12c and fourth surface 12d of multilayer body 12.

Although the number of first internal electrode layers 16a is not particularly limited, for example, the number is preferably not smaller than 160 and not larger than 328. Although the number of second internal electrode layers 16b is not particularly limited, for example, the number is preferably not smaller than 160 and not larger than 328. Therefore, the total number of first internal electrode layers 16a and second internal electrode layers 16b is, for example, preferably not smaller than 320 and not larger than 656.

Although the number of third internal electrode layers 16c is not particularly limited, for example, the number is preferably not smaller than one and not larger than two.

Although a thickness of first internal electrode layer 16a is not particularly limited, the thickness is preferably, for example, not smaller than about 0.38 μm and not larger than about 0.55 μm. Although a thickness of second internal electrode layer 16b is not particularly limited, the thickness is preferably, for example, not smaller than about 0.38 μm and not larger than about 0.55 μm. Although a thickness of third internal electrode layer 16c is not particularly limited, the thickness is preferably, for example, not smaller than about 0.38 μm and not larger than about 0.55μ m.

Third internal electrode layer 16c includes an opposing portion 22 opposed to first internal electrode layer 16a arranged in each of first outer layer portion 20a and second outer layer portion 20b. Third internal electrode layer 16c may be arranged in at least only one of first outer layer portion 20a and second outer layer portion 20b. In first outer layer portion 20a or second outer layer portion 20b where third internal electrode layer 16c is arranged, first internal electrode layer 16a is arranged, and this first internal electrode layer 16a and third internal electrode layer 16c define opposing portion 22.

A length in first direction y of third internal electrode layer 16c is shorter than a length in first direction y of second internal electrode layer 16b. In other words, an L gap dimension l₁ in capacitance generating portion 18 is smaller than an L gap dimension l₂ of third internal electrode layer 16c.

A thickness of dielectric layer 14 located in opposing portion 22 is, for example, at least about two times as large as a thickness of dielectric layer 14 located in capacitance generating portion 18.

Coverage of f dielectric layer 14 by third internal electrode layer 16c located in opposing portion 22 is, for example, preferably equal to or higher than about 90%.

Third internal electrode layer 16c is preferably located closest to first surface 12a, in first outer layer portion 20a. Third internal electrode layer 16c is preferably located closest to second surface 12b, in second outer layer portion 20b.

For example, as shown in FIG. 10, in a modification of third internal electrode layer 16c, third opposing electrode portion 25c of third internal electrode layer 16c may not extend in the direction toward third surface 12c and the direction toward fourth surface 12d and a width in first direction y in which third surface 12c and fourth surface 12d are aligned, of third opposing electrode portion 25c of third internal electrode layer 16c may be equal or substantially equal to a width in first direction y in which third surface 12c and fourth surface 12d are aligned, of third extension portion 28a and fourth extension portion 28b of third internal electrode layer 16c.

Inclusion of, for example, an Sn layer between first internal electrode layer 16a and second internal electrode layer 16b, and dielectric layer 14 can relax concentration of electric field to an interface between internal electrode layer 16 and dielectric layer 14, which leads to improved reliability against loads at a high temperature.

First internal electrode layer 16a and second internal electrode layer 16b can be made of, for example, an appropriate conductive material such as metal such as Ni, Cu, Ag, Pd, or Au or an alloy including at least one of those metals, such as an Ag—Pd alloy.

### External Electrode

External electrode 30 is arranged on a side of third surface 12c and a side of fourth surface 12d and on a side of fifth surface 12e and a side of sixth surface 12f, of multilayer body 12. External electrode 30 includes a first external electrode 30a, a second external electrode 30b, a third external electrode 30c, and a fourth external electrode 30d.

First external electrode 30a is arranged on third surface 12c. First external electrode 30a is connected to first internal electrode layer 16a. Furthermore, the first external electrode may also be arranged on a portion of first surface 12a and a portion of second surface 12b and on a portion of fifth surface 12e and a portion of sixth surface 12f.

Second external electrode 30b is arranged on fourth surface 12d. Second external electrode 30b is connected to first internal electrode layer 16a. Furthermore, the second external electrode may also be arranged on a portion of first surface 12a and a portion of second surface 12b and on a portion of fifth surface 12e and a portion of sixth surface 12f.

Third external electrode 30c is arranged on fifth surface 12e. Third external electrode 30c is connected to second internal electrode layer 16b. Furthermore, third external electrode 30c may include a first cover portion 30c1 that covers second internal electrode layer 16b exposed at fifth surface 12e, a first fold-back portion 30c: provided parallel or substantially in parallel to second internal electrode layer 16b on first surface 12a, and a second fold-back portion 30c3 provided in parallel or substantially in parallel to second internal electrode layer 16b on second surface 12b. With second fold-back portion 30c3, reliability of electrical connection to a mount substrate 50 can be further improved.

Fourth external electrode 30d is arranged on sixth surface 12f. Fourth external electrode 30d is connected to second internal electrode layer 16b. Furthermore, fourth external electrode 30d may include a second cover portion 30d₁ (not shown) that covers second internal electrode layer 16b exposed at sixth surface 12f, a third fold-back portion 30d₂ provided in parallel or substantially in parallel to second internal electrode layer 16b on first surface 12a, and a fourth fold-back portion 30d3 provided in parallel or substantially in parallel to second internal electrode layer 16b on second surface 12b. With fourth fold-back portion 30d₃, reliability of electrical connection to mount substrate 50 can be further improved.

External electrode 30 includes an underlying electrode layer 32 arranged on a surface of multilayer body 12 and a plated layer 34 arranged to cover underlying electrode layer 32.

Underlying electrode layer 32 includes a first underlying electrode layer 32a, a second underlying electrode layer 32b, a third underlying electrode layer 32c, and a fourth underlying electrode layer 32d.

Plated layer 34 includes a first plated layer 34a, a second plated layer 34b, a third plated layer 34c, and a fourth plated layer 34d.

In other words, first external electrode 30a includes first underlying electrode layer 32a and first plated layer 34a. Second external electrode 30b includes second underlying electrode layer 32b and second plated layer 34b. Third external electrode 30c includes third underlying electrode layer 32c and third plated layer 34c. Fourth external electrode 30d includes fourth underlying electrode layer 32d and fourth plated layer 34d.

First underlying electrode layer 32a is arranged on a surface of third surface 12c of multilayer body 12 and extends from third surface 12c to cover a portion of each of first surface 12a, second surface 12b, fifth surface 12e, and sixth surface 12f.

Second underlying electrode layer 32b is arranged on a surface of fourth surface 12d of multilayer body 12 and extends from fourth surface 12d to cover a portion of each of first surface 12a, second surface 12b, fifth surface 12e, and sixth surface 12f.

First underlying electrode layer 32a may be arranged only on the surface of third surface 12c of multilayer body 12 and second underlying electrode layer 32b may be arranged only on the surface of fourth surface 12d of multilayer body 12.

Third underlying electrode layer 32c is arranged on a surface of fifth surface 12e of multilayer body 12 and extends from fifth surface 12e to cover a portion of each of first surface 12a and second surface 12b.

Fourth underlying electrode layer 32d is arranged on a surface of sixth surface 12f of multilayer body 12 and extends from sixth surface 12f to cover a portion of each of first surface 12a and second surface 12b.

Underlying electrode layer 32 includes, for example, at least one of a baked layer, a conductive resin layer, a thin-film layer, or the like.

A configuration in each case where underlying electrode layer 32 is includes the baked layer, the conductive resin layer, or the thin-film layer will be described below.

### Case of Baked Layer

The baked layer includes a glass component and a metallic component. The glass component of the baked layer includes, for example, at least one of B, Si, Ba, Mg, Al, Li, or the like. The metallic component of the baked layer includes at least one of, for example, Cu, Ni, Ag, Pd, an Ag—Pd alloy, Au, or the like. The baked layer may include a plurality of layers. The baked layer is obtained by applying a conductive paste including the glass component and the metallic component to multilayer body 12 and baking the conductive paste. The baked layer may be obtained by simultaneous firing of a multilayer chip including internal electrode layer 16 and dielectric layer 14 and the conductive paste applied to the multilayer chip, or by firing the multilayer chip including internal electrode layer 16 and dielectric layer 14 to obtain multilayer body 12 and thereafter applying the conductive paste to multilayer body 12 and baking the conductive paste. In an example where the baked layer is obtained by simultaneous firing of the multilayer chip including internal electrode layer 16 and dielectric layer 14 and the conductive paste applied to the multilayer chip, the baked layer is preferably formed by baking a material obtained by addition of a dielectric material instead of the glass component.

A thickness in first direction y in which third surface 12c and fourth surface 12d are aligned and at the central portion in layering direction x, of first underlying electrode layer 32a located on third surface 12c is, for example, preferably not smaller than about 10 μm and not larger than about 30 μm.

A thickness in first direction y in which third surface 12c and fourth surface 12d are aligned and at the central portion in layering direction x, of second underlying electrode layer 32b located on fourth surface 12d is, for example, preferably not smaller than about 10 μm and not larger than about 30 μm.

In an example where first underlying electrode layer 32a is provided on a portion of first surface 12a and a portion of second surface 12b and a portion of fifth surface 12e and a portion of sixth surface 12f, a thickness in layering direction x in which first surface 12a and second surface 12b are aligned and at the central portion in first direction y in which third surface 12c and fourth surface 12d are aligned, of first underlying electrode layer 32a located on first surface 12a and second surface 12b is preferably, for example, not smaller than about 3 μm and not larger than about 10 μm. Furthermore, a thickness in second direction z in which fifth surface 12e and sixth surface 12f are aligned and at the central portion in first direction y in which third surface 12c and fourth surface 12d are aligned, of first underlying electrode layer 32a located on fifth surface 12e and sixth surface 12f is preferably, for example, not smaller than about 3 μm and not larger than about 10 μm.

In an example where second underlying electrode layer 32b is provided on a portion of first surface 12a and a portion of second surface 12b and a portion of fifth surface 12e and a portion of sixth surface 12f, a thickness in layering direction x in which first surface 12a and second surface 12b are aligned and at the central portion in first direction y in which third surface 12c and fourth surface 12d are aligned, of second underlying electrode layer 32b located on first surface 12a and second surface 12b is preferably, for example, not smaller than about 3 μm and not larger than about 10 μm. Furthermore, a thickness in second direction z in which fifth surface 12e and sixth surface 12f are aligned and at the central portion in first direction y in which third surface 12c and fourth surface 12d are aligned, of second underlying electrode layer 32b located on fifth surface 12e and sixth surface 12f is preferably, for example, not smaller than about 3 μm and not larger than about 10 μm.

A thickness of third underlying electrode layer 32c located on fifth surface 12e, in second direction z in which fifth surface 12e and sixth surface 12f are aligned and at the central portion in first direction y in which third surface 12c and fourth surface 12d are aligned is preferably, for example, not smaller than about 10 μm and not larger than about 30 μm.

A thickness of fourth underlying electrode layer 32d located on sixth surface 12f, in second direction z in which fifth surface 12e and sixth surface 12f are aligned and at the central portion in first direction y in which third surface 12c and fourth surface 12d are aligned is preferably, for example, not smaller than about 10 μm and not larger than about 30 μm.

A thickness of third underlying electrode layer 32c located on first surface 12a, in layering direction x in which first surface 12a and second surface 12b are aligned and at the central portion in first direction y in which third surface 12c and fourth surface 12d are aligned is preferably, for example, not smaller than about 3 μm and not larger than about 10 μm.

A thickness of fourth underlying electrode layer 32d located on first surface 12a, in layering direction x in which first surface 12a and second surface 12b are aligned and at the central portion in first direction y in which third surface 12c and fourth surface 12d are aligned is preferably, for example, not smaller than about 3 μm and not larger than about 10 μm.

A thickness of third underlying electrode layer 32c located on second surface 12b, in layering direction x in which first surface 12a and second surface 12b are aligned and at the central portion in first direction y in which third surface 12c and fourth surface 12d are aligned is preferably, for example, not smaller than about 3 μm and not larger than about 10 μm.

A thickness of fourth underlying electrode layer 32d located on second surface 12b, in layering direction x in which first surface 12a and second surface 12b are aligned and at the central portion in first direction y in which third surface 12c and fourth surface 12d are aligned is preferably, for example, not smaller than about 3 μm and not larger than about 10 μm.

### Case of Conductive Resin Layer

The conductive resin layer may be arranged on the baked layer to cover the baked layer or may be directly arranged on multilayer body 12 without the baked layer being provided. The conductive resin layer may completely cover the baked layer or cover a portion of the baked layer. Furthermore, the conductive resin layer may include a plurality of layers.

The conductive resin layer includes thermosetting resin and metal. Since the conductive resin layer includes thermosetting resin, it is more flexible than the baked layer made, for example, from a plated film or a fired product of the conductive paste. Therefore, even when physical impact or impact originating from a thermal cycle is applied to multilayer ceramic capacitor 10, the conductive resin layer can define and function as a buffer layer, and cracking of multilayer ceramic capacitor 10 can be prevented.

Ag, Cu, Ni, Sn, or Bi or an alloy including the same can be used as metal to be included in the conductive resin layer, for example. Metallic powders including surfaces coated with Ag, for example, can also be used. In using metallic powders including surfaces coated with Ag, for example, powders of Cu, Ni, Sn, or Bi or an alloy thereof are preferably used as metallic powders. The reason why conductive metallic powders of Ag are used for conductive metal is that Ag is lowest in specific resistance among metals and thus suitable for an electrode material and Ag is precious metal and thus it is not oxidized and highly weather resistant. In addition, the reason is that, while characteristics of Ag above are maintained, the base metal can be inexpensive.

Furthermore, for example, Cu or Ni subjected to antioxidation treatment can also be used as metal to be included in the conductive resin layer. Metallic powders including surfaces coated with, for example, Sn, Ni, or Cu can also be used as metal to be included in the conductive resin layer. In using metallic powders including surfaces coated with Sn, Ni, or Cu, powders of, for example, Ag, Cu, Ni, Sn, or Bi or an alloy thereof are preferably used as metallic powders.

Metal included in the conductive resin layer is mainly responsible for an electrical conduction property of the conductive resin layer. Specifically, as conductive fillers come in contact with each other, an electrical conduction path is provided inside the conductive resin layer.

Although metal in a spherical shape, a flat shape, or the like can be included in the conductive resin layer, spherical metallic powders and flat metallic powders are preferably mixed for use.

Various known thermosetting resins such as, for example, epoxy resin, phenol resin, urethane resin, silicone resin, or polyimide resin can be used as resin for the conductive resin layer. Among these resins, epoxy resin with excellent resistance to heat, resistance to moisture, adhesiveness, or the like is one of most appropriate resins.

The conductive resin layer preferably includes a hardening agent together with the thermosetting resin. In an example where epoxy resin is used as base resin, various known compounds such as a phenol based compound, an amine based compound, an acid anhydride based compound, an imidazole based compound, an active ester based compound, or an amide-imide based compound can be used as the hardening agent for epoxy resin.

A largest thickness portion of the conductive resin layer preferably has a thickness, for example, not smaller than about 20 μm and not larger than about 40 μm.

### Case of Thin-Film Layer

In an example where the thin-film layer is provided as underlying electrode layer 32, the thin-film layer is a layer formed with a thin-film formation method such as sputtering or vapor deposition, for example, and it is a layer not larger than about 1 μm obtained by deposition of metallic particles.

Plated layer 34 is arranged to cover underlying electrode layer 32.

Plated layer 34 includes at least one of, for example, Cu, Ni, Sn, Ag, Pd, an Ag—Pd alloy, Au, or the like.

Plated layer 34 may include a plurality of layers. In this case, plated layer 34 preferably has a two-layered structure including, for example, Ni plating and Sn plating. An Ni plated layer is used to prevent erosion of underlying electrode layer 32 by solder during mounting of multilayer ceramic capacitor 10. An Sn plated layer, for example, is used to improve solderability to allow easy mounting during mounting of multilayer ceramic capacitor 10. A thickness per one plated layer of plated layers 34 is, for example, preferably not smaller than about 1 μm and not larger than about 6 μm.

External electrode 30 may include only the plated layer without providing underlying electrode layer 32.

A structure where the plated layer is provided without underlying electrode layer 32 being provided will be described below, although it is not shown.

In any or each of first external electrode 30a, second external electrode 30b, third external electrode 30c, and fourth external electrode 30d, the plated layer may be directly provided on the surface of multilayer body 12 without underlying electrode layer 32 being provided. In other words, multilayer ceramic capacitor 10 may have a structure including the plated layer electrically connected to first internal electrode layer 16a and second internal electrode layer 16b. In such a case, a catalyst may be disposed on the surface of multilayer body 12 as a pretreatment, and thereafter the plated layer may be provided.

In an example where the plated layer is directly provided on multilayer body 12 without underlying electrode layer 32 being provided, a decrease in thickness corresponding to the absence of underlying electrode layer 32 can result in a lower profile, that is, a smaller thickness, or into a thickness of multilayer body 12, that is, a thickness of capacitance generating portion 18, and thus a degree of freedom in design of a small-thickness chip can be improved.

The plated layer preferably includes a lower plated electrode provided on the surface of multilayer body 12 and an upper plated electrode provided on a surface of the lower plated electrode. The lower plated electrode and the upper plated electrode each preferably include, for example, at least one metal of Cu, Ni, Sn, Pb, Au, Ag, Pd, Bi, Zn, or the like or an alloy including the metal. Furthermore, for example, the lower plated electrode preferably includes Ni that defines and functions as a barrier against solder and the upper plated electrode preferably includes Sn or Au which is excellent in solderability.

For example, in an example where first internal electrode layer 16a and second internal electrode layer 16b include Ni, the lower plated electrode preferably includes Cu which is joins well to Ni. The upper plated electrode should only be provided as necessary, and each of first external electrode 30a, second external electrode 30b, third external electrode 30c, and fourth external electrode 30d may include only the lower plated electrode. The plated layer may include the upper plated electrode as an outermost layer, or another plated electrode may be further provided on a surface of the upper plated electrode.

In an example where external electrode 30 includes only the plated layer without underlying electrode layer 32 being provided, a thickness per one plated layer of the plated layers arranged without underlying electrode layer 32 being provided is, for example, preferably not smaller than about 1 μm and not larger than about 15 μm.

Furthermore, the plated layer preferably does not include glass. A ratio of metal per unit volume of the plated layer is, for example, preferably not lower than about 99 volume %.

A dimension in first direction y of multilayer ceramic capacitor 10 including multilayer body 12 and external electrode 30 is defined as an L dimension. The L dimension is, for example, preferably not smaller than about 1.00 mm and not larger than about 1.30 mm.

A dimension in layering direction x of multilayer ceramic capacitor 10 including multilayer body 12 and external electrode 30 is defined as a T dimension. The T dimension is, for example, preferably not smaller than about 0.40 mm and not larger than about 0.65 mm.

A dimension in second direction z of multilayer ceramic capacitor 10 including multilayer body 12 and external electrode 30 is defined as a W dimension. The W dimension is, for example, preferably not smaller than about 0.40 mm and not larger than about 0.95 mm.

Multilayer ceramic capacitor 10 shown in FIG. 1 includes in first outer layer portion 20a, opposing portion 22 where first internal electrode layer 16a and third internal electrode layer 16c are opposed to each other and includes in second outer layer portion 20b, opposing portion 22 in which first internal electrode layer 16a and third internal electrode layer 16c are opposed to each other. Therefore, the current path for the radio-frequency current that flows to the GND becomes shorter and the low ESL can be achieved.

Since L gap dimension 1: of opposing portion 22 arranged in first outer layer portion 20a or second outer layer portion 20b is larger than L gap dimension 11 in capacitance generating portion 18 in multilayer ceramic capacitor 10 shown in FIG. 1, moisture resistance reliability can be improved.

Furthermore, by setting the thickness of dielectric layer 14 included in opposing portion 22 to be at least about two times as large as the thickness of dielectric layer 14 included in capacitance generating portion 18 in multilayer ceramic capacitor 10 shown in FIG. 1, moisture resistance reliability can further be improved.

### 2. Mount Structure for Multilayer Ceramic Capacitor

In succession, a mount structure for a multilayer ceramic capacitor according to an example embodiment of the present invention will be described with reference to FIGS. 11 and 12.

A mount structure 100 for a multilayer ceramic capacitor according to an example embodiment includes multilayer ceramic capacitor 10 according to the present example embodiment and mount substrate 50 as shown in FIGS. 11 and 12. Mount substrate 50 includes a core material 51 of a substrate and a conductor land 52. Core material 51 of the substrate is, for example, a substrate including a material obtained by impregnation of a base material in which glass fabric (cloth) and nonwoven glass fabric have been blended with, for example, epoxy resin or polyimide resin or a ceramic substrate manufactured by baking a sheet in which ceramic and glass have been mixed. Core material 51 of the substrate may be a substrate including a single layer or a substrate including a plurality of layers that are layered.

Although a thickness of core material 51 of the substrate is not particularly limited, the thickness is preferably, for example, not smaller than about 0.2 mm and not larger than about 1.6 mm.

One main surface of core material 51 of the substrate defines a substrate-side mount surface 51a which includes conductor land 52 and defines and functions as a mount surface where multilayer ceramic capacitor 10 is to be mounted.

Conductor land 52 includes a first conductor land 52a, a second conductor land 52b, a third conductor land 52c, and a fourth conductor land 52d.

First conductor land 52a is a portion electrically connected and mechanically joined to first external electrode 30a of multilayer ceramic capacitor 10 by a joint material 54. Second conductor land 52b is a portion electrically connected and mechanically joined to second external electrode 30b of multilayer ceramic capacitor 10 by joint material 54. Third conductor land 52c is a portion electrically connected and mechanically joined to third external electrode 30c of multilayer ceramic capacitor 10 by joint material 54. Fourth conductor land 52d is a portion electrically connected and mechanically joined to fourth external electrode 30d of multilayer ceramic capacitor 10 by joint material 54.

Conductor land 52 may be provided on a main surface opposite to substrate-side mount surface 51a of core material 51 of the substrate.

Although a material for conductor land 52 is not particularly limited, for example, metal such as copper, gold, palladium, or platinum can be used. Although a thickness, that is, a dimension in layering direction x, of conductor land 52 is not particularly limited, for example, it is preferably, for example, not smaller than about 20 μm and not larger than about 200 μm. For example, solder or a highly heat resistant epoxy-based adhesive can be used as joint material 54.

In the description above, mount substrate 50 corresponds to the mount substrate. Core material 51 of the substrate corresponds to the core material of the substrate. Substrate-side mount surface 51a corresponds to the mount surface. A plurality of conductor lands 52 correspond to the plurality of connection conductors. The connection conductor is not limited by other applications, functions, shapes, names, and the like as long as it is a conductor provided between the multilayer ceramic capacitor and the mount substrate to be able to electrically connect them to each other, in addition to what is called a land.

Mount structure 100 for the multilayer ceramic capacitor shown in FIGS. 11 and 12 is mounted on mount substrate 50 such that second surface 12b of multilayer ceramic capacitor 10 faces substrate-side mount surface 51a. The multilayer ceramic capacitor may be mounted on mount substrate 50 such that first surface 12a of multilayer ceramic capacitor 10 faces substrate-side mount surface 51a.

Therefore, various functions of multilayer ceramic capacitor 10 according to the present example embodiment of the present invention described above are provided as they are on mount structure 100 for multilayer ceramic capacitor 10 shown in FIGS. 11 and 12, and third internal electrode layer 16c includes opposing portion 22 opposed to first internal electrode layer 16a arranged in at least one of first outer layer portion 20a and second outer layer portion 20b and the multilayer ceramic capacitor is mounted such that first surface 12a including first outer layer portion 20a or second surface 12b including second outer layer portion 20b faces the mount substrate. Therefore, the current path from third internal electrode layer 16c of multilayer ceramic capacitor 10 to mount substrate 50 can be shorter. Consequently, the advantageous effect to improve low ESL characteristics in the mount structure for the multilayer ceramic capacitor with the various advantageous effects of multilayer ceramic capacitor 10 according to the present example embodiment of the present invention being provided is achieved.

### 3. Method of Manufacturing Multilayer Ceramic Capacitor

An example of a method of manufacturing multilayer ceramic capacitor 10 according to an example embodiment of the present invention will now be described.

Initially, a dielectric sheet for a dielectric layer and a conductive paste for an internal electrode are prepared. The dielectric sheet and the conductive paste for the internal electrode layer include a binder and a solvent. The binder and the solvent may be a known binder and a known solvent.

The conductive paste for the internal electrode layer is printed on the dielectric sheet in a prescribed pattern, for example, by screen printing, gravure printing, or the like. The dielectric sheet where the pattern of the first internal electrode layer has been formed and the dielectric sheet where the pattern of the second internal electrode layer has been formed are thus prepared.

More specifically, a gravure printing plate for forming the first internal electrode layer and the second internal electrode layer and a gravure printing plate for forming the first internal electrode layer and the third internal electrode layer are separately prepared, and the internal electrode layer can be formed.

In order to obtain a desired structure, a sheet on which the first internal electrode layer has been printed and a sheet on which the second internal electrode layer has been printed are alternately layered to form a portion to be capacitance generating portion 18. By layering the sheet on which the first internal electrode layer has been printed and a sheet on which the third internal electrode layer has been printed, a portion to be the opposing portion to be arranged in the first outer layer portion or the second outer layer portion is formed.

A prescribed number of dielectric sheets on which a pattern of the internal electrode layer has not been printed are then layered to form a portion to be the second outer layer portion on the side of the second surface. At some time point during layering of the second outer layer portion, the first internal electrode layer and the third internal electrode layer are layered adjacently with the dielectric sheet being interposed, so that the opposing portion is arranged in the second outer layer portion. Thereafter, the portion to be the capacitance generating portion formed through steps described above is layered on the portion to be the second outer layer portion. Thereafter, a prescribed number of dielectric sheets on which the pattern of the internal electrode layer has not been printed are layered on the portion to be the capacitance generating portion, to form the portion to be first outer layer portion 20a on the side of first surface 12a. At some time point during layering of the first outer layer portion, the first internal electrode layer and the third internal electrode layer are layered adjacently with the dielectric sheet being interposed, so that the opposing portion is arranged in the first outer layer portion. A multilayer sheet is thus provided.

In succession, the multilayer sheet is pressed in the layering direction with, for example, isostatic pressing to make a multilayer block.

The multilayer block is then cut into multilayer chips each having a prescribed size. At this time, a corner portion and a ridgeline portion of the multilayer chip may be rounded by barrel polishing or the like, for example.

The cut multilayer chips are then fired to make multilayer bodies 12. A firing temperature is, for example, preferably not lower than about 900° C. and not higher than about 1400° C., depending on a material for dielectric layer 14 or internal electrode layer 16.

### Underlying Electrode Layer

In succession, third underlying electrode layer 32c of third external electrode 30c is formed on fifth surface 12e of multilayer body 12 obtained by firing and fourth underlying electrode layer 32d of fourth external electrode 30d is formed on sixth surface 12f of multilayer body 12.

In an example where the baked layer is formed as underlying electrode layer 32, the conductive paste including the glass component and the metallic component is applied, thereafter baking treatment is performed, and the baked layer is formed as underlying electrode layer 32. A temperature for baking treatment at this time is, for example, preferably not lower than about 700° C. and not higher than about 900° C. In the present example embodiment, underlying electrode layer 32 is formed from the baked layer.

Various methods can be used as a method of forming the baked layer. For example, a technique to align orientations of multilayer bodies 12 with the use of a camera or a magnet such that fifth surface 12e or sixth surface 12f faces down and to thereafter hold multilayer body 12 with a holding jig, and to apply the conductive paste by extruding the conductive paste through a slit or a hole can be used. In the case of this technique, an amount of extrusion of the conductive paste can be increased to form third underlying electrode layer 32c and fourth underlying electrode layer 32d not only on fifth surface 12e and sixth surface 12f but also on a portion of first surface 12a and a portion of second surface 12b.

First underlying electrode layer 32a of first external electrode 30a is then formed on third surface 12c of multilayer body 12 obtained by firing and second underlying electrode layer 32b of second external electrode 30b is formed on fourth surface 12d of multilayer body 12. In the present example embodiment, first underlying electrode layer 32a and second underlying electrode layer 32b are formed with, for example, a dip method to extend not only at third surface 12c and fourth surface 12d but also to a portion of first surface 12a and a portion of second surface 12b and a portion of fifth surface 12e and a portion of sixth surface 12f.

In baking treatment, first underlying electrode layer 32a of first external electrode 30a, second underlying electrode layer 32b of second external electrode 30b, third underlying electrode layer 32c of third external electrode 30c, and fourth underlying electrode layer 32d of fourth external electrode 30d may be simultaneously baked, or first underlying electrode layer 32a of first external electrode 30a and second underlying electrode layer 32b of second external electrode 30b may be baked separately from third underlying electrode layer 32c of third external electrode 30c and fourth underlying electrode layer 32d of fourth external electrode 30d.

### Conductive Resin Layer

In an example where underlying electrode layer 32 is formed from the conductive resin layer, the conductive resin layer can be formed with an example of a method below. The conductive resin layer may be formed on a surface of the baked layer, or the conductive resin layer alone may be directly formed on multilayer body 12 without the baked layer being formed.

In forming the conductive resin layer, a conductive resin paste including thermosetting resin and a metallic component is applied to the baked layer or multilayer body 12 and subjected to heat treatment at a temperature not lower than 250° C. and not higher than 550° C., for example, so that the resin is thermally set to form the conductive resin layer. An atmosphere for heat treatment at this time is, for example, preferably an Ne atmosphere. In order to prevent resin from scattering and preventing various metallic components from being oxidized, a concentration of oxygen is, for example, preferably about 100 ppm or lower.

In applying the conductive resin paste, similarly to the method of forming underlying electrode layer 32 from the baked layer, for example, the technique to apply the conductive resin paste by, for example, the dip method, extrusion through the slit, or a roller transfer method can be used.

### Thin-Film Layer

In an example where underlying electrode layer 32 is formed from the thin-film layer, underlying electrode layer 32 can be formed by, for example, masking and a thin-film formation method such as sputtering or vapor deposition at a position where formation of external electrode 30 is desired. Underlying electrode layer 32 formed from the thin-film layer is a layer, for example, not larger than about 1 μm obtained by deposition of metallic particles.

### Plated Payer

External electrode 30 may be formed only from the plated layer without underlying electrode layer 32 being provided. In that case, the external electrode can be formed with an example of a method below.

Third surface 12c and fourth surface 12d of multilayer body 12 are subjected to plating treatment to form a lower plated electrode at an exposed portion of first internal electrode layer 16a. Similarly, fifth surface 12e and sixth surface 12f of multilayer body 12 are subjected to plating treatment to form a lower plated electrode at an exposed portion of second internal electrode layer 16b. In performing plating treatment, any of electrolytic plating and electroless plating may be used. Electroless plating, however, is disadvantageous in that pretreatment with a catalyst or the like is required in order to improve a plating deposition rate and a process is complicated. Therefore, electrolytic plating is preferably normally used. Barrel plating, for example, is preferably used as a plating technique. An upper plated electrode to be formed on a surface of the lower plated electrode may similarly be formed as necessary.

Finally, plated layer 34 is formed. Plated layer 34 may be formed on the surface of underlying electrode layer 32 or formed directly on multilayer body 12. In the present example embodiment, plated layer 34 is formed on the surface of underlying electrode layer 32. More specifically, for example, on underlying electrode layer 32, the Ni plated layer is formed as a lower plated layer and the Sn plated layer is formed as an upper plated layer. In performing plating treatment, any of electrolytic plating and electroless plating may be used. Electroless plating, however, is disadvantageous in that pretreatment with a catalyst or the like is required in order to improve a plating deposition rate and a process is complicated. Therefore, electrolytic plating is preferably normally used.

Multilayer ceramic capacitor 10 according to the present example embodiment is manufactured as described above.

### 4. Experimental Example

In order to check the advantageous effects of the multilayer ceramic capacitor according to an example embodiment described above, a multilayer ceramic capacitor was then manufactured as a sample for an experiment, and evaluation based on a moisture resistance reliability test and the ESL was produced, with each of the L gap dimension of the third internal electrode layer and the thickness of the dielectric layer located in the opposing portion where the first internal electrode layer and the third internal electrode layer were opposed to each other being varied.

### (1) Specifications of Multilayer Ceramic Capacitor Made as Sample in Experimental Example

A multilayer ceramic capacitor which was a sample in each of Comparative Examples 1 to 3 and Examples 1 to 4 was made with the manufacturing method according to the example embodiment above.
Structure of multilayer ceramic capacitor: three terminals (see FIG. 1)
Dimension (L) of multilayer ceramic capacitor: about 1.25 mm
Dimension (W) of multilayer ceramic capacitor: about 0.85 mm
Dimension (T) of multilayer ceramic capacitor: about 0.45 mm
Thickness of dielectric layer located in capacitance generating portion: about 0.46 μm
Thickness of internal electrode layer: about 0.40 μm.
The number of first internal electrode layers: 230.
The number of second internal electrode layers: 230
Thickness of first outer layer portion: about 20 μm
Thickness of second outer layer portion: about 20 μm
L gap dimension in capacitance generating portion: about 38 μm
W gap dimension: about 45 μm
L gap dimension of third internal electrode layer: about 38 μm, about 48 μm, about 59 μm, and about 67 μm
Thickness of dielectric layer located in opposing portion formed from first internal electrode layer and third internal electrode layer: about 0.46 μm and about 0.92 μm
Structure of external electrode.
   First external electrode and second external electrode
Underlying electrode layer: baked layer including conductive metal (Cu) and glass component
Plated layer: two-layered structure of Ni plated layer and Sn plated layer.
   Third external electrode and fourth external electrode
Underlying electrode layer: baked layer including conductive metal (Cu) and glass component
Plated layer: two-layered structure of Ni plated layer and Sn plated layer

Each sample according to Examples included the third internal electrode layer in the first outer layer portion and the second outer layer portion, and the L gap dimension of the third internal electrode layer arranged in the outer layer portion was varied in a range larger than the L gap dimension in the capacitance generating portion. Each sample according to Examples 2 to 4 had the thickness of the dielectric layer located in the opposing portion arranged in the outer layer portion two times as large as the thickness of the dielectric layer located in the capacitance generating portion.

The sample according to Comparative Example 1 was the three-terminal multilayer ceramic capacitor the same or substantially the same as the multilayer ceramic capacitors in Examples except for the absence of the third internal electrode layer in the first outer layer portion and the second outer layer portion.

The sample according to each of Comparative Example 2 and Comparative Example 3 included the third internal electrode layer in the first outer layer portion and the second outer layer portion. In Comparative Example 2 and Comparative Example 3, however, the L gap dimension in the capacitance generating portion was equal or substantially equal to the L gap dimension of the third internal electrode layer arranged in the outer layer portion.

### (2) Moisture Resistance Reliability Test

Moisture resistance reliability was tested in a pressure cooker bias test (PCBT). Test conditions included about 125° C. and a relative humidity of about 95% RH, and in such an environment, an insulation test was conducted by maintaining for about seventy-two hours, a state in which a DC voltage of about 4 V was applied across the external electrodes in the multilayer ceramic capacitor according to each sample. An insulation resistance value of the multilayer ceramic capacitor according to each sample after this insulation test was then measured. An example where the insulation resistance value after the moisture resistance test was smaller by an order of magnitude than the insulation resistance value before the insulation test was determined as defective (NG). Seventy-two samples for each example were prepared.

### (3) ESL Measurement Method

The sample labeled with each sample number was mounted on the mount substrate each provided with the mount surface to make a sample of a circuit board. An ESL value was measured by measuring an impedance across the external electrodes through a land of the circuit board. Specifically, the ESL value of each sample was measured with the use of a network analyzer (company name: manufactured by Agilent, model No: E5080A), between the first external electrode or the second external electrode and the third external electrode or the fourth external electrode when a frequency was set to about 1 GHz. Ten samples labeled with a sample number for each example were prepared. The ESL value of the sample labeled with each sample number was calculated as an average value of the ten samples.

### (4) Results

Table 1 shows results of evaluation based on the moisture resistance reliability test and the ESL, with the L gap dimension of the third internal electrode layer and the thickness of the dielectric layer located in the opposing portion where the first internal electrode layer and the third internal electrode layer were opposed to each other being varied.

TABLE 1

| | | Comparative Example | | | Example | | | |
|---|---|---|---|---|---|---|---|---|
| | | 1 | 2 | 3 | 1 | 2 | 3 | 4 |
| Thickness of Dielectric Layer Located | (μm) | 0.46 | 0.46 | 0.46 | 0.46 | 0.46 | 0.46 | 0.46 |
| in Capacitance Forming Portion | | | | | | | | |
| L Gap Dimension in Capacitance Forming Portion: I₁ | (μm) | 38 | 38 | 38 | 38 | 38 | 38 | 38 |
| Thickness of Dielectric Layer Located | (μm) | None | 0.46 | 0.92 | 0.46 | 0.92 | 0.92 | 0.92 |
| in Opposing Portion Arranged | | | | | | | | |
| in Outer Layer Portion | | | | | | | | |
| L Gap Dimension of Third Internal Electrode | (μm) | None | 38 | 38 | 67 | 48 | 59 | 67 |
| Layer Arranged in Outer Layer Portion: I₂ | | | | | | | | |
| Moisture Resistance Reliability Test | (Count) | 0/72 | 24/72 | 12/72 | 3/72 | 1/72 | 0/72 | 0/72 |
| ESL Measurement Result | (pH) | 21.5 | 20.7 | 20.5 | 20.3 | 20.5 | 20.6 | 20.3 |

It was confirmed according to Table 1 that, in each sample in Examples 1 to 4, the L gap dimension of the third internal electrode layer arranged in the outer layer portion was larger than the L gap dimension in the capacitance generating portion, in other words, the length in first direction y of the third internal electrode layer was shorter than the length in first direction y of the second internal electrode layer, and thus the results of the moisture resistance reliability test were good and the ESL could be lower than in the results of measurement of the ESL in Comparative Example 1. This may be because the opposing portion where the first internal electrode layer and the third internal electrode layer were opposed to each other was arranged in the outer layer portion so that the current path for the radio-frequency current that flowed to the GND was shorter and the ESL was lowered.

It was confirmed that each sample in Examples 2 to 4 achieved further improvement in the results of the moisture resistance reliability test because the thickness of the dielectric layer located in the opposing portion arranged in the outer layer portion was about two times as large as the thickness of the dielectric layer located in the capacitance generating portion.

In Comparative Example 2 and Comparative Example 3, the third internal electrode layer was arranged in the outer layer portion. Regarding the third internal electrode layer in each of Comparative Example 2 and Comparative Example 3, however, the L gap dimension in the capacitance generating portion was equal or substantially equal to the L gap dimension of the third internal electrode layer arranged in the outer layer portion, and thus there were many samples determined as being defective according to the results of the moisture resistance reliability test.

It was confirmed in the results above that both of the moisture resistance reliability and the low ESL could be achieved by providing the third internal electrode layer in the outer layer portion and setting the length in first direction y of the third internal electrode layer to be shorter than the length in first direction y of the second internal electrode layer.

Although example embodiments of the present invention are described in the description as set forth above, the present invention is not limited thereto.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of layered dielectric layers and a plurality of internal electrode layers layered on the dielectric layers, a first surface and a second surface opposed to each other in a layering direction, a third surface and a fourth surface opposed to each other in a first direction orthogonal or substantially orthogonal to the layering direction, and a fifth surface and a sixth surface opposed to each other in a second direction orthogonal or substantially orthogonal to the layering direction and the first direction;
a first external electrode on the third surface;
a second external electrode on the fourth surface;
a third external electrode on the fifth surface; and
a fourth external electrode on the sixth surface; wherein
the plurality of internal electrode layers include:
a first internal electrode layer on the plurality of dielectric layers and exposed at the third surface and the fourth surface;
a second internal electrode layer on the plurality of dielectric layers and exposed at the fifth surface and the sixth surface; and
a third internal electrode layer on the plurality of dielectric layers and exposed at the fifth surface and the sixth surface;
the multilayer body includes:
a capacitance generating portion in which the first internal electrode layer and the second internal electrode layer are opposed to each other to generate a capacitance;
a first outer layer portion between the first surface and the capacitance generating portion; and
a second outer layer portion between the second surface and the capacitance generating portion;
the third internal electrode layer includes an opposing portion opposed to the first internal electrode layer in at least any one of the first outer layer portion and the second outer layer portion; and
a length in the first direction of the third internal electrode layer is shorter than a length in the first direction of the second internal electrode layer.

2. The multilayer ceramic capacitor according to claim 1, wherein a thickness of one of the plurality of dielectric layers in the opposing portion is at least about two times a thickness of one of the plurality of dielectric layers in the capacitance generating portion.

3. The multilayer ceramic capacitor according to claim 2, wherein a thickness of each of the first outer layer portion and the second outer layer portion is equal to or larger than about 20 μm.

4. The multilayer ceramic capacitor according to claim 3, wherein the third internal electrode layer is closest to the first surface in the first outer layer portion or closest to the second surface in the second outer layer portion.

5. The multilayer ceramic capacitor according to claim 4, wherein the thickness of the one of the plurality of dielectric layers in the capacitance generating portion is not smaller than about 0.44 μm and not larger than about 0.60 μm, and a thickness of one of the plurality of internal electrode layers in the capacitance generating portion is not smaller than about 0.38 μm and not larger than about 0.55 μm.

6. The multilayer ceramic capacitor according to claim 5, wherein a coverage of the one of the plurality of dielectric layers by the one of the plurality of internal electrode layers in the opposing portion is equal to or higher than about 90%.

7. The multilayer ceramic capacitor according to claim 1, wherein each of the plurality of dielectric layers includes BaTiO₃, CaTiO₃, SrTiO₃, or CaZro₃.

8. The multilayer ceramic capacitor according to claim 1, wherein the third internal electrode layer is not exposed at the third surface or the fourth surface.

9. The multilayer ceramic capacitor according to claim 1, wherein each of the first and second internal electrode layers includes Ni, Cu, Ag, Pd, or Au or an alloy including at least one of Ni, Cu, Ag, Pd, or Au.

10. The multilayer ceramic capacitor according to claim 1, wherein each of the first, second, third, and fourth external electrodes includes an underlying electrode layer and a plated layer covering the underlying electrode layer.

11. A mount structure for a multilayer ceramic capacitor comprising:
a mount substrate; and
the multilayer ceramic capacitor according to claim 1 mounted on the mount substrate; wherein
the mount substrate includes:
a core material of a substrate;
a first connection conductor connected to the first external electrode arranged on the core material;
a second connection conductor connected to the second external electrode arranged on the core material;
a third connection conductor connected to the third external electrode arranged on the core material; and
a fourth connection conductor connected to the fourth external electrode arranged on the core material; and
the multilayer ceramic capacitor is mounted such that the first surface or the second surface faces the mount substrate.

12. The mount structure according to claim 11, wherein a thickness of one of the plurality of dielectric layers in the opposing portion is at least about two times a thickness of one of the plurality of dielectric layers in the capacitance generating portion.

13. The mount structure according to claim 12, wherein a thickness of each of the first outer layer portion and the second outer layer portion is equal to or larger than about 20 μm.

14. The mount structure according to claim 13, wherein the third internal electrode layer is closest to the first surface in the first outer layer portion or closest to the second surface in the second outer layer portion.

15. The mount structure according to claim 14, wherein the thickness of the one of the plurality of dielectric layers in the capacitance generating portion is not smaller than about 0.44 μm and not larger than about 0.60 μm, and a thickness of the one of the plurality of internal electrode layers in the capacitance generating portion is not smaller than about 0.38 μm and not larger than about 0.55 μm.

16. The mount structure according to claim 15, wherein a coverage of the one of the plurality of dielectric layers by the one of the plurality of internal electrode layers in the opposing portion is equal to or higher than about 90%.

17. The mount structure according to claim 11, wherein each of the plurality of dielectric layers includes BaTiO₃, CaTiO₃, SrTiO₃, or CaZro₃.

18. The mount structure according to claim 11, wherein the third internal electrode layer is not exposed at the third surface or the fourth surface.

19. The mount structure according to claim 11, wherein each of the first and second internal electrode layers includes Ni, Cu, Ag, Pd, or Au or an alloy including at least one of Ni, Cu, Ag, Pd, or Au.

20. The mount structure according to claim 11, wherein each of the first, second, third, and fourth external electrodes includes an underlying electrode layer and a plated layer covering the underlying electrode layer.
